(19) United States
(12) Patent Application Publication
(10) Pub. No.: US 2026/0208176 A1
(43) Pub. Date: Jul. 23, 2026

(54) Artificial Photosynthesis Device and a Process for Production of C1/C2 Compounds

(71) Applicant: COUNCIL OF SCIENTIFIC & INDUSTRIAL RESEARCH, New Delhi (IN)

(72) Inventors: Chinnakonda Subramanian GOPINATH, Pune (IN); Kranti Nishikant SALGAONKAR, Pune (IN)

(21) Appl. No.: 19/141,897

(22) PCT Filed: Dec. 21, 2023
(86) PCT No.: PCT/IN2023/051210

§ 371 Date: Jun. 20, 2025

(30) Foreign Application Priority Data
Dec. 22, 2022 (IN) 202211074765

(51) Int. Cl. B01J 35/39; B01J 23/68; B01J 35/30; B01J 35/77; B01J 37/02; B01J 37/08

(52) U.S. Cl. CPC B01J 35/39; B01J 23/682; B01J 35/393; B01J 35/77; B01J 37/0215; B01J 37/0236; B01J 37/08

(57) ABSTRACT

The present disclosure relates generally to the field of artificial photosynthesis. More particularly, the present disclosure provides an artificial photosynthesis device and a process for fabrication thereof. Aspects of the present disclosure also provide a photocatalytic material and a process for production thereof. Further aspect of the present disclosure relates to a process for production of C₁/C₂ compounds from CO₂ and H₂O with the help of the artificial photosynthesis device with a solar to fuel efficiency of 14.7%.

### FIELD OF THE INVENTION

The present disclosure relates generally to the field of artificial photosynthesis. More particularly, the present disclosure provides an artificial photosynthesis device and a process for fabrication thereof. Aspects of the present disclosure also provide a photocatalytic material and a process for production thereof. Further aspect of the present disclosure relates to a process for production of C₁/C₂ compounds from CO₂ and H₂O with the help of the artificial photosynthesis device with a solar to fuel efficiency of 14.7%.

### BACKGROUND OF THE INVENTION

For climate change mitigation, transforming carbon dioxide back into useful carbon-based liquid/gaseous fuel and value added chemicals is one of the biggest technological challenges of this century. Such successful demonstration would contribute to carbon-neutral economy. Mimicking natural photosynthesis in green plants, where CO₂ is converted to carbohydrates under ambient conditions, via artificial leaf approach for transformation of CO₂ to C₁ and/or higher homologous carbon containing products is the main objective of the present work. As compared to C₁-containing products, the interest in multi-carbon C₂₊ chemicals (hydrocarbons, multi-carbon oxygenates, gasoline etc.) is very attractive due to their high energy density, and the possibility of employing them in the transportation sector and chemical industries for variety of applications.

Several attempts have been made to achieve CO₂ to C₂₊ product conversion with very limited success by photocatalysis. The article entitled “Reduced Cu/Pt—HCa₂Ta₃O₁₀ Perovskite Nanosheets for Sunlight-Driven Conversion of CO₂ into Valuable Fuels” by Trong-On-Do, published in the journal, Advanced Sustainable Systems, volume 1, September 2017, 1700048 reports significant ethanol formation from CO₂ conversion, and the ethanol yield reported to be 113 μmol/g.h. In this article, CuO and Pt nanoparticles are simultaneously loaded on reduced HCa₂Ta₃O₁₀ perovskite nanosheet and subjected to simulated sunlight with CO₂ saturated water vapor forming ethanol and methanol with formation rates of 113 and 7.4 μmol/g.h, respectively; while, only methanol is observed at the rate of 125.9 μmol/g.h with Pt nanoparticles and without CuO. The selectivity of methanol and ethanol after 10 hours of reaction is 5.3 and 94.7%, respectively. It may be noted that activity reported is in μmol/g.h; further, it requires the presence of Pt as the noble metal. As reviewed in the recent report by Gopinath and Nalajala, published in the Journal of Materials Chemistry A Vol. 9, 2021, 1353, any photocatalyst is unlikely to increase the activity in the powder form.

The article entitled, Copper-decorated TiO₂nanorod thin films in optofluidic planar reactors for efficient photocatalytic reduction of CO₂ by Huang et al., published in the International Journal of Hydrogen Energy, volume 42, 2017, 9722-9732. In this article, photocatalytic CO₂ reduction is evaluated with the different weight percentages of Cu loaded on TiO₂ nanorod thin films under UV-LED of wavelength 365 nm under a continuous flow of CO₂ with water vapor of 2 ml/min at 60° C. with the specially designed optofluidic planar reactor. The highest production of methanol and ethanol is reported to be 24.42 and 47.25 μmol/g.h, respectively, with 1.5 wt % Cu²⁺ loaded on TiO₂nanorod thin films. Even though this photocatalyst is in thin film form, there is no activity reported in the visible light or sunlight as this photocatalyst works only under UV light. Although the photocatalyst material reported in this article may be economical, its applicability in direct sunlight is poor along with activity in the μmol/g.h regime.

The article entitled, Bi₂MoO₆ quantum dots in situ grown on reduced graphene oxide layers: a novel electron rich interface for efficient CO₂ reduction by Sheglian Luo published in ACS Applied Materials and Interfaces, Vol. 12, 2020, 25861-25874 deals with in-situ growth of Bi₂MoO₆ quantum dots (QDs) on different amount of reduced graphene oxide (GO) by hydrothermal method. Formation of 5 nm sized Bi₂MoO₆QDs on GO enables the electron injection from photoexcited Bi₂MoO₆QDs into GO layer, thus providing an electron rich interface for CO₂ reduction. Activity for CO₂ reduction has been tested for synthesized catalyst under 300 W Xe lamp with 20 mg of catalyst in 30 ml water bubbled with continuous pure CO₂ gas and the reaction temperature is maintained at 4° C. With Bi₂MoO₆/10rGO, only liquid products are observed; methanol and ethanol formation rate is reported to be 21.2 and 14.4 μmol/g.h, respectively. No other liquid/gaseous products were observed with this catalyst. Bi₂MoO₆ QDs with 10rGO shows 2.2 times more alcohol production that unmodified Bi₂MoO₆ quantum dots and 4.4 times more alcohol production that flower like Bi₂MoO₆. It is important to measure the activity in direct sunlight and without any temperature control.

The article entitled “Facet-dependent active sites of as single Cu₂O particle photocatalyst for CO₂ reduction to methanol” by Y. A Wu et al., published in Nature Energy, 4, 2019, 957 also reports a very high CO₂ conversion to methanol, at the rate of 1.2 mol/h.g of the catalyst with solar to fuel (STF) efficiency of 10%. However, experiments were carried out with 10 mg of Cu₂O nanoparticles in powder form and suspended in water, and continuously purged with CO₂/H₂O gas mixture till the solution is saturated with CO₂. CO₂ saturated Cu₂O containing solution is illuminated with a 300 W Xe lamp between 0 and 60 min. under continuous CO₂/H₂O flow and the product is analyzed periodically. 10 mg of particulate catalyst produces 0.133 mmol/s·g of methanol and yet to be demonstrated at higher scale; although it is claimed to produce 1.2 mol/h.g methanol through simple weight normalization, 0.133 mmol/s·g and 1.2 mol/h.g do not match by extrapolation from second to hour by a factor of 3600. It is to be noted that, unlike conventional catalysis, there are many difficulties/issues associated with scaling up the photocatalysis experiments with larger amount of photocatalysts and indeed lower activity is reported at higher scale (eg. 1 g level) of catalysts.

Recently Gopinath and Salgaonkar, inventors of the present disclosure, reported on Photocatalyst device for continuous process for co-conversion of CO₂+H₂O to Cl-oxygenates in sunlight in WO 2022/044039 A1. This work employed integration of BiVO₄ with titania in thin film form and demonstrated the conversion of CO₂ and water in sunlight to a mixture of formaldehyde and methanol. CO₂ conversion efficiency of 35-55% was reported with a possibility of fine tuning the selectivity of product towards a desired product.

Thus, there is still need for photocatalytic material/device which is efficient in terms of high STF, easy to use and better for production of C₁/C₂ compounds from CO₂ & H₂O.

### OBJECTIVE OF THE INVENTION

The main objective of the present invention is to provide an artificial photosynthesis device and a process for fabrication thereof.

Another objective of the invention is to provide a photocatalytic material and a process for production thereof.

Yet another aspect of present invention is to provide a process for production of C₁/C₂ compounds from CO₂ and H₂O with the help of the artificial photosynthesis device.

Still another objective of present invention is to provide a process for production of C₁/C₂ compounds from CO₂ and H₂O with the help of the artificial photosynthesis device with efficiency of 14.7%.

### SUMMARY OF THE INVENTION

Accordingly the present invention provides a photocatalytic material, comprising: semiconductor quantum dots, a porous semiconductor, and a support; wherein the semiconductor quantum dots comprise a 3d transition metal oxide, a 4d transition metal oxide, and/or mixtures thereof, wherein the porous semiconductor is supported onto said support in the form of a thin film; and wherein the semiconductor quantum dots are integrated, structurally and electronically, into pores of the porous semiconductor and on exterior surface of the semiconductor.

In an embodiment of present invention, the 3d transition metal oxide is oxide of metal selected from titanium (Ti), vanadium (V), chromium (Cr), manganese (Mn), iron (Fe), cobalt (Co), nickel (Ni), copper (Cu) and zinc (Zn); and wherein the 4d transition metal oxide is oxide of metal selected from zirconium (Zr), niobium (Nb), molybdenum (Mo), ruthenium (Ru), rhodium (Rh), palladium (Pd), and silver (Ag).

In another embodiment of present invention, the semiconductor quantum dots are selected from Ag₃VO₄ nanoparticles; wherein the semiconductor quantum dots are in orthorhombic crystal structure and monoclinic crystal structure or mixture thereof; and the porous semiconductor is selected from TiO₂, ZnO and polymorphs thereof; and the support is selected from glass plate, FTO plate, indium tin oxide (ITO) glass plate, a fluorine-doped tin oxide (FTO) glass plate, silicon wafer and steel plate.

In another embodiment of present invention, the semiconductor quantum dots have a particle size ranging from 1 nm to 10 nm; and wherein the porous semiconductor is supported onto said support in the form of a thin film has a thickness in the range of 5-20 μm or 8 to 14 μm.

In another embodiment of present invention, the material comprises heterojunctions between said semiconductor quantum dots and porous semiconductor, wherein the number of heterojunctions is in range of 276 to 711 trillions/cm².mg.

In another embodiment, the present invention provides a process of preparation of photocatalytic material, wherein the process comprise steps: (i) preparing a porous semiconductor supported onto a support by coating porous semiconductor paste onto the support to obtain a thin film, (ii) drying the film of step (i) at a temperature in the range of 50 to 70° C. for time period of 1.5 to 3 hrs, (iii) calcining the dried film of step (ii) at a temperature in the range of 400 to 500° C. for time period of 20 to 45 minutes to obtain the porous semiconductor supported onto a support as thin film; and (iv) adding an ionic precursor or 1^{st} and 2^{nd} ionic precursors corresponding to the semiconductor quantum dots with said porous semiconductor supported onto a support of step (iii) via successive ionic layer adsorption and reaction (SILAR) method to obtain the photocatalytic material.

In yet another embodiment of present invention, the porous semiconductor paste is prepared by process steps of: i) stirring and sonicating porous semiconductor powder in solvent or mixture of solvents selected from ethanol and glacial acetic acid for time period of 5 to 25 mins to obtain a mixture; ii) mixing, stirring and sonicating an ethyl cellulose with said mixture of step i) for time period of 5 to 25 minutes; and iii) mixing, stirring and sonicating terpeniol with the mixture of step ii) for time period of 20 to 45 min to obtain the porous semiconductor paste.

In yet another embodiment of present invention, the SILAR method further comprising steps of:
a) immersing the porous semiconductor supported onto a support thin film in an aqueous solution of 1st ionic precursor at a temperature in the range of 25 to 35° C. for time period in the range of 5 to 60 seconds;
b) immersing the film in 2nd ionic precursor at a temperature in the range of 70-75° C. for time period in the range of 5 to 60 seconds;
c) repeating the process of step a) and b) for at least two times to obtain a crude photocatalytic material;
d) rinsing the crude material of step c) with water;
e) drying at temperature in the range of 60-70° C. or time period of 1-2 hrs; and
f) annealing the dried material at a temperature in the range of 400 to 500° C. for time period in the range of 1.5 to 3 hrs to obtain the photocatalytic material.

In yet another embodiment of present invention wherein the 1st ionic precursor is silver nitrate; wherein the 2nd ionic precursor is selected from ammonium metavanadate and sodium orthovanadate; wherein the concentration of 1st ionic precursor is in range of 10-300 mmol;

and wherein the concentration of 2nd ionic precursor is in range of 10-300 mmol.

In yet another embodiment the present invention provides a process of preparation of C₁/C₂ compounds with the photocatalytic material as claimed in claim 1, wherein said process comprises steps of,
a) placing the photocatalytic material with a co-catalyst in a reactor and adding water as a hydrogen source to the reactor;
b) saturating the reactor of step a) with CO₂ gas at a temperature in the range of 1 to 5° C. for a time period of 30 to 60 minutes to obtain CO₂ saturated mixture;
c) exposing the mixture of step b) with a light at a pH in the range of 6.8-7.2 for a time period in the range of 4 to 10 hrs to obtain the C₁/C₂ compounds selected from CO, CH₄, methanol, ethanol and mixtures thereof.

In yet another embodiment of present invention the co-catalyst is a metal selected from platinum (Pt), nickel (Ni), copper (Cu), nickel-copper (NiCu) alloy, nickel iron (NiFe) alloy, platinum coated NiCu alloy, and mixture thereof and the light is selected from a UV-visible-near IR light, a visible light, a visible-near IR light and direct sunlight or combinations thereof.

### BRIEF DESCRIPTION OF DRAWINGS

FIG. 1A illustrates exemplary snippets showing the artificial leaf devices viz. (i) AMVT-based and (ii) AOVT-based, realized in accordance with the embodiments of the present disclosure.

FIG. 1B illustrates an exemplary UV-visible absorption spectra of photoanode, realized in accordance with an embodiment of the present disclosure, with a digital photograph (shown in inset) for color associated with photoanodes.

FIG. 2 illustrates exemplary HRTEM images of AMVT photoanode, realized in accordance with an embodiment of the present disclosure, showing Ag₃VO₄ QDs formed inside pores of TiO₂ with the formation of heterojunction between them.

FIG. 3 illustrates exemplary HRTEM images of AOVT photoanode, realized in accordance with an embodiment of the present disclosure, showing Ag₃VO₄ QDs formed inside as well as outside pores of TiO₂ with the formation of heterojunction between them.

FIG. 4 illustrates an exemplary XRD pattern of (left) AMVT and (right) AOVT catalysts with corresponding standard JCPDS diffraction patterns, realized in accordance with embodiments of the present disclosure.

FIG. 5 illustrates an exemplary characterization of CO₂ reduction products observed with AMVT-based artificial leaf device, realized in accordance with an embodiment of the present disclosure, and analyzed by GC and NMR methods.

FIG. 6 illustrates an exemplary characterization of CO₂ reduction products observed with AOVT-based artificial leaf device, realized in accordance with an embodiment of the present disclosure, and analyzed by GC and NMR methods.

FIG. 7 illustrates an exemplary CO₂ conversion and products selectivity obtained as a function of irradiation time with AMVT-based artificial leaf device, realized in accordance with an embodiment of the present disclosure.

FIG. 8 illustrates an exemplary CO₂ conversion and products selectivity obtained as a function of irradiation time with AOVT-based artificial leaf device, realized in accordance with an embodiment of the present disclosure.

### DETAILED DESCRIPTION OF THE INVENTION

The terms “photocatalytic material”, “artificial photosynthesis device”, “artificial leaf device” and “thin film device” used herein interchangeably throughout the specification with the similar meaning. The present disclosure relates generally to the field of artificial photosynthesis. More particularly, the present disclosure provides an artificial photosynthesis device and a process for fabrication thereof. Aspects of the present disclosure also provide a photocatalytic material and a process for production thereof. Further aspect of the present disclosure relates to a process for production of C₁/C₂ compounds from CO₂ and H₂O with the help of the artificial photosynthesis device. Artificial photosynthesis is a process that employs the artificial leaf (AL) device and they may be used synonymously.

Further aspect of the present disclosure relates to a process for production of C₁/C₂ compounds from CO₂ and H₂O with the help of the artificial photosynthesis device with a solar to fuel efficiency of 14.7%.

An aspect of the present disclosure provides a photocatalytic material, said material comprising semiconductor quantum dots integrated with a porous semiconductor, wherein semiconductor quantum dots comprises a 3d transition metal oxide, a 4d transition metal oxide, and mixtures thereof.

In some embodiments, the semiconductor quantum dots are integrated, structurally and electronically, exclusively into pores of the semiconductor. In some embodiments, the semiconductor quantum dots are integrated, structurally and electronically, into pores of the semiconductor and on exterior surface of the semiconductor. In some embodiments, the porous semiconductor comprises a wide-bandgap semiconductor. In some embodiments, the porous semiconductor comprises TiO₂, ZnO and polymorphs thereof. In some embodiments, the semiconductor quantum dots comprise Ag₃VO₄. In some embodiments, the material comprises Ag₃VO₄ quantum dots integrated with TiO₂ semiconductor, wherein the Ag₃VO₄ quantum dots are integrated, structurally and electronically, at least into the pores of TiO₂ semiconductor. In some embodiments, the Ag₃VO₄ quantum dots have a particle size ranging from 1 nm to 10 nm.

The porous semiconductor is in porous or micro and mesoporous in nature.

Another aspect of the present disclosure relates to a process for production of a photocatalytic material comprising semiconductor quantum dots integrated with a porous semiconductor, said semiconductor quantum dots comprising a 3d transition metal oxide, a 4d transition metal oxide, and mixtures thereof, the process comprising: (a) taking a porous semiconductor; (b) taking ionic precursor compounds corresponding to the 3d transition metal oxide, the 4d transition metal oxide, and mixtures thereof; and (c) effecting successive ionic layer adsorption and reaction (SILAR) by contacting the porous semiconductor with the precursors.

In some embodiments, the ionic precursor compounds are water and/or alcohol soluble compounds. In some embodiments, the step of contacting the porous semiconductor with the precursors is effected for a time period ranging from 5-60 seconds. In some embodiments, the process further includes the step of annealing after the successive ionic layer adsorption and reaction (SILAR) is effected, the step of annealing comprising: exposing the porous semiconductor adsorbed with the transition metal oxide to a temperature ranging from 200° C. to 600° C. for a time period ranging from 20 minutes to 6 hours. In some embodiments, the porous semiconductor comprises a wide-bandgap semiconductor. In some embodiments, the porous semiconductor comprises TiO₂, ZnO and polymorphs thereof. In some embodiments, the semiconductor quantum dots comprise Ag₃VO₄. In some embodiments, the ionic precursor compounds comprise: a transition metal salt, and a vanadyl salt. In some embodiments, the vanadyl salt is selected from metavanadate salt, orthovanadate salt and mixtures thereof.

In an exemplary embodiment, thin film of porous semiconductor (TiO₂) is prepared by doctor blade method, for example, of uniform thickness 9±1 μm. To introduce transition metal oxide quantum dots (QDs) for example, of Ag₃VO₄, into the pores of titania thin film, SILAR method is used, wherein Ag⁺ and vanadyl species containing solutions are taken in a particular sequence. SILAR helps in assembling Ag₃VO₄ QDs of particle size 1-5 nm uniformly in the mesopores of TiO₂ and distribution over the entire thickness of the film. High-resolution images show that Ag₃VO₄ QDs are spherical in shape with particle size in the range of 1 to 5 nm. Distinct heterostructure between Ag₃VO₄ and TiO₂ can be observed due to the employment of the SILAR method for the assembly of QDs in mesoporous TiO₂. Mesoporous TiO₂ film allows the diffusion of small size ionic precursor components of Ag⁺ and VO₃⁻ through interlayer spacing of abundant (101) and other facets of TiO₂ (3.5 Å) and thus Ag₃VO₄ QDs form in the pores of TiO₂ upon calcination. The heterostructure of Ag₃VO₄ and TiO₂ observed over entire device thickness helps in unique electron-hole separation as well as dispersion of electrons towards the cathode.

In some embodiments, different vanadyl species precursors (metavanadate and orthovanadate) along with silver nitrate are utilized in SILAR method to form silver vanadate. To introduce Ag₃VO₄ into the pores of titania thin film, by SILAR method, silver nitrate and ammonium metavanadate solutions can be taken as precursors (resultant photoanode thin film is termed hereinafter as “AMVT” thin film). Alternatively, silver nitrate and sodium orthovanadate solutions can be taken as precursors (resultant photoanode thin film is termed hereinafter as “AOVT” thin film). It could be noted that AMVT photoanode absorb in the visible region up to 580 nm, while the photoanode AOVT absorb over the entire visible region. Thus, the fabricated AOVT photoanode absorbs 57% of the solar spectrum, particularly and critically the entire visible and significant near IR range wavelength photons. With the usage of different vanadyl species, in SILAR method, different crystalline patterns can be observed with Ag₃VO₄ QDs. The AMVT photoanode, where ammonium metavanadate is used as vanadyl species, exhibits an orthorhombic crystalline phase, while the AOVT shows monoclinic crystallite phase of Ag₃VO₄. Further, the number of Ag₃VO₄ QDs formed for every TiO₂ particle is higher with AOVT, as compared to AMVT. Thus, AOVT demonstrates the formation of larger number of heterojunctions of Ag₃VO₄ QDs and TiO₂ within one single particle. Such heterojunction formation is uniformly observed over the entire thin film.

Further aspect of the present disclosure provides an artificial photosynthesis device, said device comprising: (a) a photoanode comprising semiconductor quantum dots integrated with a porous semiconductor, wherein semiconductor quantum dots comprises a 3d transition metal oxide, a 4d transition metal oxide, and mixtures thereof; and (b) a co-catalyst.

In some embodiments, the semiconductor quantum dots are integrated, structurally and electronically, exclusively into pores of the semiconductor. In some embodiments, the semiconductor quantum dots are integrated, structurally and electronically, into pores of the semiconductor and on exterior surface of the semiconductor. In some embodiments, the porous semiconductor comprises a wide-bandgap semiconductor. In some embodiments, the porous semiconductor comprises TiO₂, ZnO and polymorphs thereof. In some embodiments, the semiconductor quantum dots comprise Ag₃VO₄. In some embodiments, the photoanode comprises Ag₃VO₄ quantum dots integrated with TiO₂ semiconductor, wherein the Ag₃VO₄ quantum dots are integrated, structurally and electronically, at least into the pores of TiO₂ semiconductor. In some embodiments, the Ag₃VO₄ quantum dots have a particle size ranging from 1 nm to 10 nm. In some embodiments, the co-catalyst is a transition metal. In some embodiments, the co-catalyst is selected from Pt, Ni, Cu, NiCu alloy, NiFe, Pt-coated NiCu alloy and mixtures thereof.

Still further aspect of the present disclosure relates to a process for fabrication of an artificial photosynthesis device, the process comprising: (a) fabricating a photoanode comprising semiconductor quantum dots integrated with a porous semiconductor, wherein semiconductor quantum dots comprises a 3d transition metal oxide, a 4d transition metal oxide, and mixtures thereof; (b) and integrating co-catalyst with the photoanode to fabricate the artificial photosynthesis device.

In some embodiments, the step of fabricating the photoanode comprises: (a) taking a porous semiconductor; (b) taking ionic precursor compounds corresponding to the 3d transition metal oxide, the 4d transition metal oxide, and mixtures thereof; (c) effecting successive ionic layer adsorption and reaction (SILAR) by contacting the porous semiconductor with the precursors; and (d) exposing the porous semiconductor adsorbed with the transition metal oxide to a temperature ranging from 200° C. to 600° C. for a time period ranging from 20 minutes to 6 hours. In some embodiments, the porous semiconductor comprises a wide-bandgap semiconductor. In some embodiments, the porous semiconductor comprises TiO₂, ZnO and polymorphs thereof. In some embodiments, the semiconductor quantum dots comprise Ag₃VO₄. In some embodiments, the ionic precursor compounds comprise: a transition metal salt, and a vanadyl salt. In some embodiments, the vanadyl salt is selected from metavanadate salt, orthovanadate salt and mixtures thereof. In some embodiments, the ionic precursor compounds are water and/or alcohol soluble compounds. In some embodiments, the step of contacting the porous semiconductor with the precursors is effected for a time period ranging from 5-60 seconds.

Some embodiments of the present disclosure provide fabrication of photoanode with trillion-quadrillion number of heterojunctions created for every mg of photoanode material by adopting a simple and efficient successive ionic layer adsorption and reaction (SILAR) synthesis method. This helps in efficient charge separation and high solar to fuel efficiency. By using the SILAR method, visible light absorbing semiconductor (e.g. Ag₃VO₄), from their ionic components can easily be assembled and integrated in the form of quantum dots (QDs) in pores of wide-band gap semiconductors such as TiO₂. Ag₃VO₄ quantum dots (QDs) can be made from different precursors, for example, metavanadate (orthorhombic, labelled as AMVT) and orthovanadate (monoclinic, labelled as AOVT), which structurally different and exhibits different light absorption characteristics. The artificial photosynthesis device (also termed as “artificial leaf device” throughout the present disclosure) of the present disclosure exhibits >10% solar to fuel efficiency in direct sunlight for conversion of CO₂ to C₁/C₂ products.

Still further aspect of the present disclosure relates to a process for production of C₁/C₂ compounds from CO₂ and H₂O, the process comprising: exposing an artificial photosynthesis device comprising: (a) a photoanode comprising semiconductor quantum dots integrated with a porous semiconductor, wherein semiconductor quantum dots comprises a 3d transition metal oxide, a 4d transition metal oxide, and mixtures thereof; and (b) a co-catalyst, to light in presence of CO₂ and H₂O to obtain the C₁/C₂ compounds. C₁/C₂ compounds (or products) can be CO, CH₄, methanol, ethanol and mixtures thereof.

In some embodiments, the artificial photosynthesis device is placed in a quartz reactor before exposing to the light. In some embodiments, the artificial photosynthesis device is exposed to a light selected from a UV-visible-near IR light, a visible light, a visible-near IR light and direct sunlight. In some embodiments, the semiconductor quantum dots are integrated, structurally and electronically, exclusively into pores of the semiconductor. In some embodiments, the semiconductor quantum dots are integrated, structurally and electronically, into pores of the semiconductor and on exterior surface of the semiconductor. In some embodiments, the porous semiconductor comprises a wide-bandgap semiconductor. In some embodiments, the porous semiconductor comprises TiO₂, ZnO and polymorphs thereof. In some embodiments, the semiconductor quantum dots comprise Ag₃VO₄. In some embodiments, the photoanode comprises Ag₃VO₄ quantum dots integrated with TiO₂ semiconductor, wherein the Ag₃VO₄ quantum dots are integrated, structurally and electronically, at least into the pores of TiO₂ semiconductor. In some embodiments, the Ag₃VO₄ quantum dots have a particle size ranging from 1 nm to 10 nm. In some embodiments, the co-catalyst is a transition metal. In some embodiments, the co-catalyst is selected from Pt, Ni, Cu, NiCu alloy, NiFe, Pt-coated NiCu alloy and mixtures thereof. The selectivity of the products, especially, towards production of methanol and ethanol, can be tuned by employing suitable co-catalyst.

In various embodiments of the present disclosure, TiO₂ with a band gap of 3.2 eV can be used as the wide-band gap semiconductor, which works only under UV light; visible light absorbing semiconductor (VLAS) (also referred to as “porous semiconductor” synonymously and interchangeably herein) can be selected from the group comprising 3d and 4d transition metal oxides, a specific example being Ag₃VO₄; co-catalyst used can include transition metal alone or in alloy form such as Ni nanoparticles, Cu nanoparticles, NiCu alloy, Pt-coated NiCu alloy and mixtures thereof.

As described in detail hereinabove, by using the SILAR method visible light absorbing semiconductor (e.g. Ag₃VO₄), from their ionic components can be assembled and integrated in the form of QDs, at least, in the pores of wide-band gap semiconductors, such as TiO₂, and further electronically integrated with TiO₂.

The photoanode of the present disclosure has few hundred trillions to quadrillion number of heterojunctions for every mg of photoanode material, by adopting a simple and efficient SILAR synthesis method, which helps in efficient charge separation and high solar to fuel efficiency. QDs (e.g. Ag₃VO₄ QDs) present in pores of porous semiconductor (e.g. TiO₂) acts as photoanode, and co-catalyst (e.g. Pt coated-NiCu alloy) acts as cathode, wherein QDs serve as visible and near IR absorbing photocatalyst, while porous semiconductor (e.g. TiO₂) predominantly absorbs UV light.

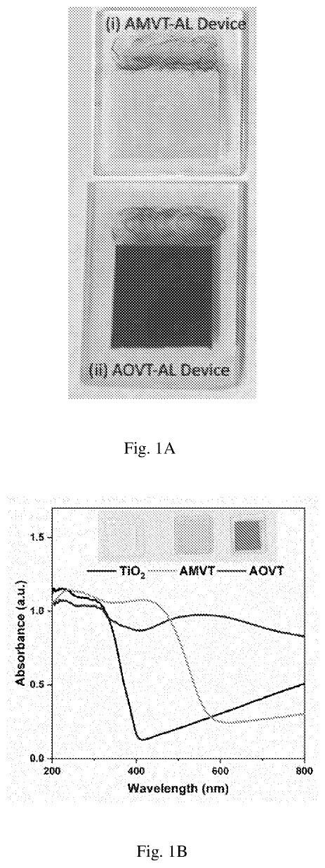

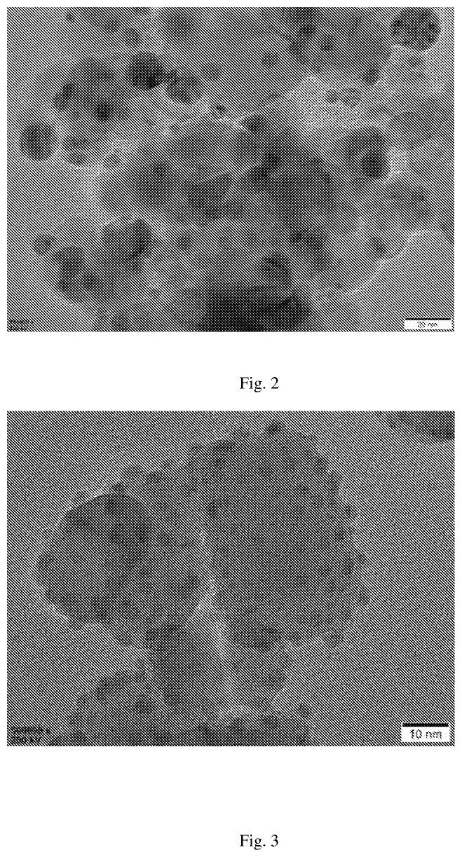

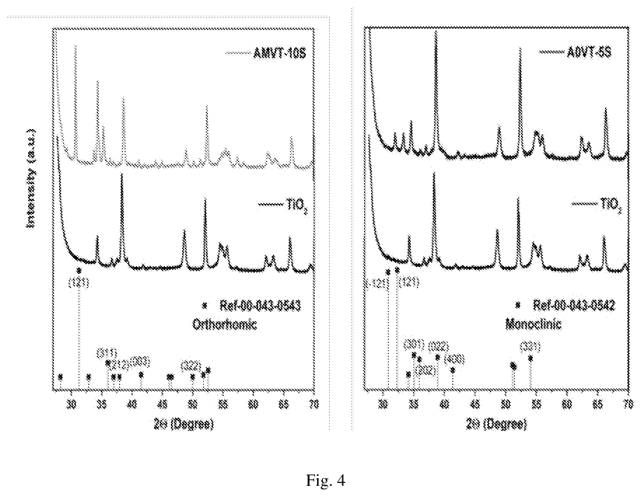

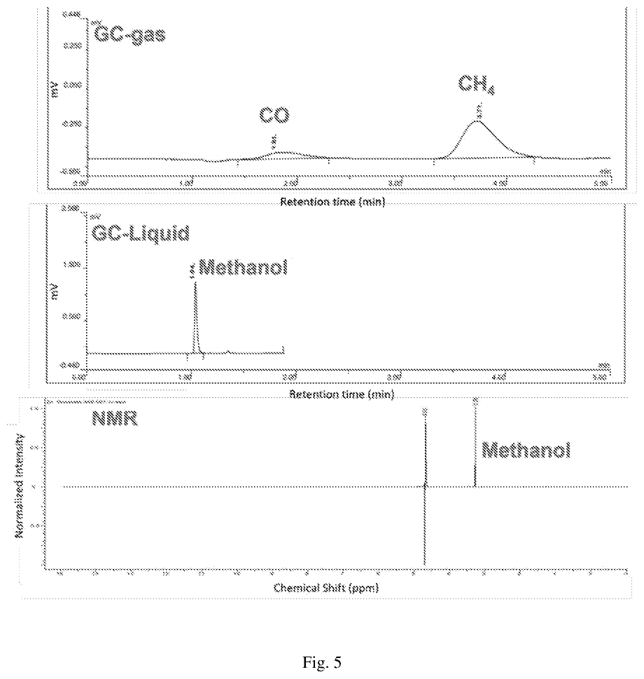

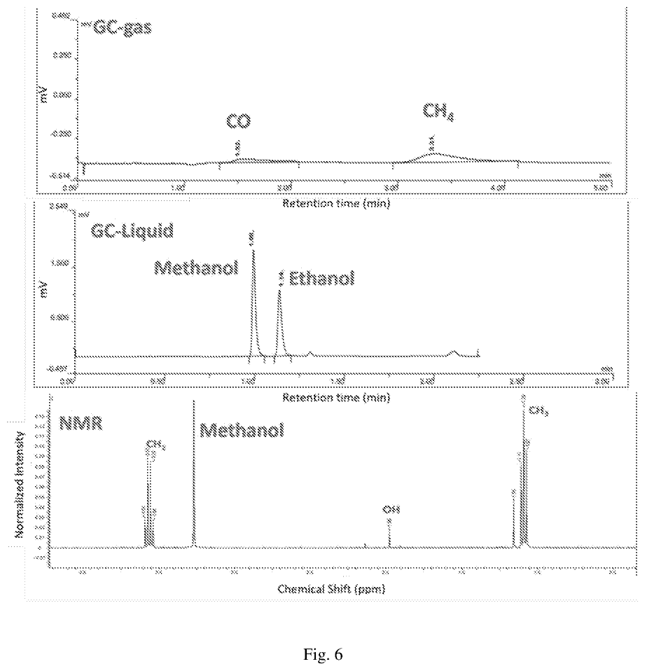

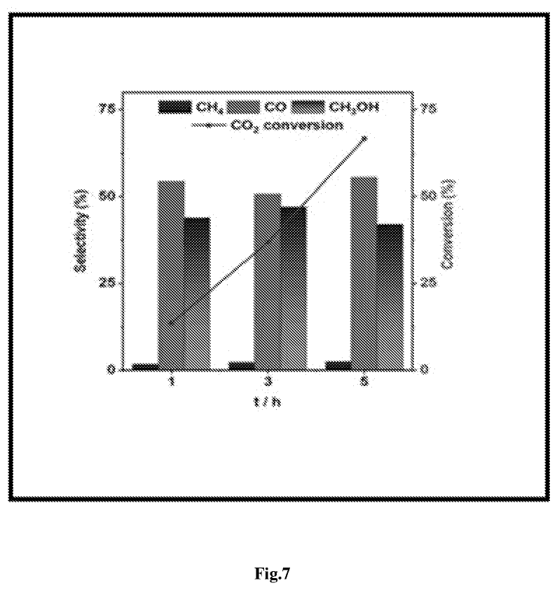

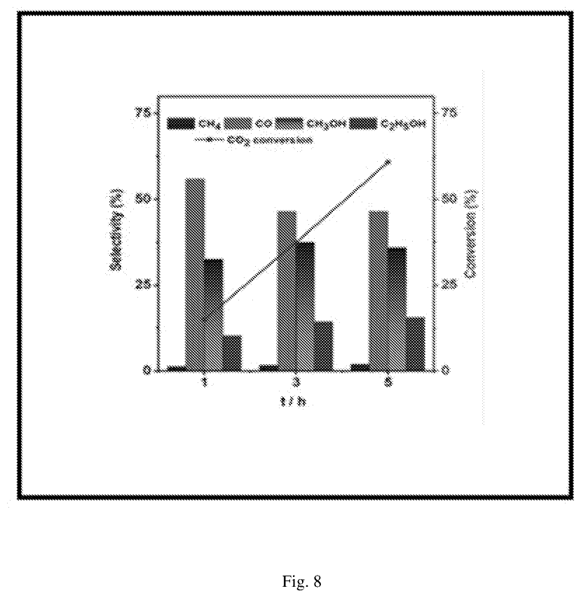

The combination of Ag₃VO₄ QDs in the pores of titania leads to very efficient visible light absorption up to 580 nm (with AMVT) and up to 800 nm (with AOVT), as observed in FIG. 1B. Further, the Ag₃VO₄ particle size was observed to be 1-5 nm and uniform 2 nm in the present findings (FIGS. 2 and 3). This leads up to 711 trillions of heterojunctions per mg of photoanode material between Ag₃VO₄ and TiO₂ in the present work, which enhances the solar-to-fuel efficiency of ethanol formation under direct sunlight as well as one sun condition. Further, the electronic nature of the photocatalytic material is better or superior (due to retaining of p-type nature, even after calcination at high temperature), which prevents the material undergoing any changes/disintegration, either under calcination or reaction conditions in the present findings.

The present invention successfully oxidizes water to oxygen and generates electrons and protons for CO₂ reduction to ethanol, CO and CH₄ using the artificial photosynthesis device. This underscores that the holes are efficiently employed to oxidize water to oxygen, proton and electrons; the latter two were consumed for CO₂ reduction to value added products. Here, the direct sunlight used herein contains 4-5% UV, ~45% Visible light, ~23% near IR light, and the remaining is IR light. Wavelength of the light and light power is important for reaction. Sunlight contains all these wavelengths and any of the light individually and with required power. FIG. 1B shows visible and UV absorption for AMVT and UV+Visible+near IR for AOVT. Light absorption is a testament for its activity, as it has been already demonstrated with sunlight, where the individual components % is lower, compared to artificially generated 100% UV or visible or near IR.

### EXAMPLES

The following examples are given by way of illustration and therefore should not be construed to limit the scope of the present invention.

### Example 1: Photoanode TiO₂ Thin Film (Porous Semiconductor) Preparation

FTO plates were chosen as substrate in this method. First, FTO plates were properly cleaned with isopropyl alcohol followed by TiCl₃ treatment on conductive side of FTO. TiO₂ paste was coated by doctor blade method to 1 cm² area of plate and dried at 60° C. for 2 h and then calcined at 450° C. for 30 min. Detailed procedure for TiO₂ paste is as follows: 1 g of TiO₂ powder (Degussa P25) was stirred for 10 min with 33 ml ethanol and 0.33 ml glacial acetic acid and then sonicated for 10 min. 0.5 g ethyl cellulose was added to the above mixture with 10 min stirring and 10 min sonication. Finally, 3 ml of terpeniol was added to the mixture and kept for 30 min stirring and sonication. After this step, solvent was evaporated to obtain a uniform thick paste by using rotavapour. This titania paste was coated on FTO plate uniformly and the thickness of such films are in the range of 8-14 μm.

### Example 2: Ag₃VO₄ Quantum Dots (QDs) Integrated into TiO₂ (AMVT) Photoanode Preparation

Ag-ion containing solution was prepared by mixing 75 mMAgNO₃ in the water. Similarly, 25 mM NH₄VO₃ solution was prepared by dissolving required amount of NH₄VO₃ in water. Both solutions were used in SILAR method to deposit AgVO₃ QDs in the porous structure of titania film. Pre-coated TiO₂ film on FTO was immersed in Ag-bath for 20 seconds followed by immersion in hot metavanadate precursor bath for the next 20 seconds. This is considered as one SILAR cycle. Precursor concentration and SILAR cycle time can be varied between 10-300 mmol and 5-60 seconds, respectively. Amount/content of QD in the titania film was gradually increased as the number of SILAR cycle subjected was increased. Film was rinsed with deionized water and dried in air after each cycle. After the application of SILAR cycles, film was annealed in air at 450° C. for 2 h to form uniform Ag₃VO₄ QDs in the pores of TiO₂. This provides the main photoanode part of the artificial leaf device with Ag₃VO₄/TiO₂ as photoanode material, named as AMVT.

### Number of Heterojunctions in AMVT Film (for Orthorhombic Structure Found in AMVT):

Here mostly 4-5 nm QDs are present, as evident from TEM results (FIG. 3) and hence calculation are made for 4 nm diameter pore size. It is assumed that titania have only 4 nm diameter pores. 4 nm diameter pores are filled with Ag₃VO₄ in the 3.5 weight percentage, and how many mesopores can be filled with 35 μg of Ag₃VO₄ in TiO₂. Volume of one 4 nm sphere is calculated to be 33.51 nm³. Experimental values for orthorhombic Ag₃VO₄ are a=8.7470 Å, b=6.7140 Å, c=6.5560 Å, and hence the volume is 0.385 nm³. It is calculated that 4 nm mesopore accomodates 87 unit cells of Ag₃VO₄. One Ag₃VO₄ unit cell contains 2 molecules of Ag₃VO₄, and hence in 4 nm mesopore can accommodate 174 molecules of Ag₃VO₄. 1 mole (or 6.02×10²³ molecules) of Ag₃VO₄=438.54 g., hence 174 molecules of Ag₃VO₄ has 12.67×10⁻²⁰ g weight in one 4 nm pore of Ag₃VO₄. It is assumed that one TiO₂ mesopore with Ag₃VO₄ QD in it generates one heterojunction; however, it could be more, which is not considered for the present calculation.

$$Number of heterojunctions ( by 4 nm ) = \frac{35 \times 1 {0}^{- 6}}{12.67 \times {10}^{- 20}} = 276 \times 1 {0}^{12}$$

276 trillions of 4 nm diameter Ag₃VO₄ particles with a weight of 35 μg was accommodated in titania pores generates a minimum of 276 trillion heterojunctions. Hence a 276 trillion heterojunctions could be possible in 1 cm² device with 1 mg AMVT photoanode material. From the pore volume analysis of P25-TiO₂ it is known that the pore volume 0.18 ml/g and this translates to 0.18×10⁻³ cm³/mg. By assuming pores are spherical in shape and 4 nm in size, each pore volume is estimated to be 33.51 nm³. A simple back calculation reveals that 1 mg of TiO₂ is expected to have 5.4×10¹⁵ mesopores of 4 nm diameter. From 5.4×10¹⁵ pores (5.4 quadrillion) of TiO₂, only 0.276×10¹⁵ pores (0.276 quadrillion) are occupied by Ag₃VO₄ QDs. This in turn indicates that 5.1% of pores are occupied by Ag₃VO₄QDs present in the pores of 1 mg of TiO₂.

### Example 3: Ag₃VO₄ QDs Integrated TiO₂ (AOVT) Photoanode Preparation

Ag-ion containing solution was prepared, as described above in example 2, by mixing 75 mM AgNO₃ in water. Similarly, 25 mM Na₃VO₄ solution was prepared by dissolving required amount of Na₃VO₄ in water. Both solutions were used in SILAR method to deposit AgVO₄ QDs in the porous structure of titania film. Pre-coated TiO₂ film on FTO was immersed in Ag-bath for 30 seconds followed by immersion in orthovanadate precursor bath for another 10 seconds. This is considered as one SILAR cycle. Precursor concentration, SILAR cycle time can be varied between 10-300 mmol and 5-60 seconds, respectively. Amount/content of QD in the titania film was gradually increased as the number of SILAR cycle subjected was increased. Film was rinsed with deionized water and dried in air after each cycle. After 5 SILAR cycles, film was annealed in air at 450° C. for 2 h to form uniform Ag₃VO₄ QDs in the pores of TiO₂. This provides the main photoanode part of the artificial leaf device with Ag₃VO₄/TiO₂ as photoanode material, named as AOVT.

Number of heterojunctions in AOVT film (For Monoclinic structure found in AOVT): Based on the HRTEM observations, it is assumed that 3 nm diameter pores of titania is filled preferentially; in addition, bigger pores are also filled, but to the volume of 3 nm pore. Smaller than 3 nm pores also would be fully filled, in reality. However, for the ease of calculation of number of heterojunctions, it is assumed that only 3 nm diameter pores of titania are filled with entire 8.5 wt percent (85 μg) of Ag₃VO₄, and how many mesopores can be filled with 85 μg of Ag₃VO₄ in TiO₂. Volume of a single 3 nm sphere is calculated to be 14.14 nm³. Experimental values for monoclinic Ag₃VO₄ is obtained from Hirono et al., Thin Solid Films, 149, L85, 1987, and the values are as follows ¹: a=8.7340 Å, b=6.7070 Å, c=6.5140 Å, and Sin β=95.36, hence the volume (a*b*c*sin β) is 0.341 nm³. It is calculated that 3 nm mesopore accomodates 41 unit cells of Ag₃VO₄. One Ag₃VO₄ unit cell contains 4 molecules of Ag₃VO₄, and hence in 3 nm mesopore can accommodate 164 molecules of Ag₃VO₄.

1 mole (or 6.023×10²³ molecules) of Ag₃VO₄=438.54 g., hence, 164 molecules of Ag₃VO₄ has 11.94×10⁻²⁰ g weight in one 3 nm pore of Ag₃VO₄. It is assumed that one TiO₂ mesopore with Ag₃VO₄QD in it generates one heterojunction; however, it could be more, which is not considered for the present calculation.

$$Number of heterojunctions ( by 3 nm ) = \frac{85 \times 1 {0}^{- 6}}{11.94 \times {10}^{- 20}} = 711 \times {10}^{12}$$

711 trillions (or 0.711 quadrillion) of 3 nm diameter Ag₃VO₄ particles with a weight of 85 μg was accommodated in titania pores generates a minimum of 711 trillion heterojunctions. Hence, 711 trillion heterojunctions could be possible in 1 cm² device with 1 mg AOVT photoanode material. From the pore volume analysis of P25-TiO₂, it is known that the pore volume 0.18 ml/g and this translates to 0.18×10⁻³ cm³/mg. By assuming pores are spherical in shape and 3 nm in size, each pore volume is estimated to be 14.14 nm³. A simple back calculation reveals that 1 mg of TiO₂ is expected to have 12.7×10¹⁵ mesopores of 3 nm diameter. From 12.7×10¹⁵ pores (12.7 quadrillion) of TiO₂, only 0.711×10¹⁵ pores (0.711 quadrillion) are occupied by Ag₃VO₄QDs. This in turn indicates that 5.6% of pores are occupied by Ag₃VO₄QDs present in the pores of 1 mg of TiO₂.

### Example 4: Synthesis of Co-Catalyst-NiCu Alloy Nanoparticles

NiCu nanoparticles were synthesized by solvothermal technique with oleylamine as capping as well as reducing agent. The detailed synthesis procedure of NiCu nanoparticles is as follows: In a 100 ml three neck round bottom flask, 25 ml of oleylamine was taken and kept at 120° C. for 10 min to remove any trace amount of water from oleylamine. 2:1 mole ratio of nickel and copper precursors, nickel (II) nitrate hexahydrate and copper (II) acetate monohydrate, was added to this preheated oleyl amine. The reaction mixture was gradually increased to 220° C. and kept for 1 h under stirring. After 1 h, colour of the solution changed from green to black, indicating the formation of NiCu alloy nanoparticles. The resultant black solution was cooled to 25° cand then the nanoparticles formed were separated by centrifugation. Followed by washing with ethanol and centrifuged; this procedure was repeated three times and finally nanoparticles are collected in ethanol solvent.

### Example 5: Synthesis of Co-Catalyst-Half Monolayer Pt Covered on NiCu Alloy (0.5θ_{Pt}-NiCu)

Half monolayer Pt covered on NiCu alloy synthesized by solvo-thermal method. As explained in Example 4, NiCu alloy nanoparticles were prepared initially. NiCu alloy treated with 1:4 NaBH₄:ethanol and stirred for 30 min in round bottom flask followed by refluxing at 80° C. for 1 h. Then it was centrifuged, washed with ethanol and named as NiCu@H⁻ as NiCu alloy surface is fully covered by hydride ions. NiCu@H⁻ the treated with K₂PtCl₄ in 8:1 ratio with ethanol in a round bottom flask under sonication for 30 min and then refluxed at 74° C. for 12 h. Then it was centrifuged, washed with ethanol and denoted as 0.5θPt@NiCu.

### Example 6: Synthesis of Co-Catalyst-Ni Nanoparticles

Ni nanoparticles were also synthesized by solvo-thermal techniques with the help of oleylamine as capping as well as reducing agent, as explained in example 4. The detailed synthesis procedure of Ni nanoparticles is as follows: In a 100 ml three neck round bottom flask, 25 ml of oleylamine was taken and kept at 120° C. for 10 min to remove any trace amount of water from oleylamine. Required amount of nickel (II) nitrate hexahydrate was added to this preheated oleylamine. The reaction mixture was gradually increased to 220° C. and kept for 1 h under stirring. After 1 h, colour of the solution changed from green to black, indicating the formation of Ni nanoparticles. The resultant black solution was cooled to 25° cand then the nanoparticles formed were separated by centrifugation. Followed by washing with ethanol and centrifugation, the Ni nanoparticles are collected and stored in ethanol solvent.

### Example 7: Synthesis of Co-Catalyst-Cu Nanoparticles

Cu nanoparticles were synthesized by solvo-thermal techniques with the help of oleylamine as capping as well as reducing agent. The detailed synthesis procedure of Cu nanoparticles is as follows: In a 100 ml three neck round bottom flask, 25 ml of oleylamine was taken and kept at 120° C. for 10 min to remove any trace amount of water from oleylamine. Required amount of copper (II) acetate monohydrate was added to this preheated oleylamine. The reaction mixture was gradually increased to 220° C. and kept for 1 h under stirring. After 1 h, colour of the solution changed from green to black, indicating the formation of Cu nanoparticles. The resultant black solution was cooled to 25° cand then the nanoparticles formed were separated by centrifugation and further washing. Finally Cu nanoparticles are collected and stored in ethanol solvent.

### Example 8: Photocatalytic CO₂ Reduction with AMVT-Based Artificial Leaf (AL) Device (Batch Process)

1 cm² area AL device was prepared by coating 1 mg of Ag₃VO₄/TiO₂ (of which 90-99 wt % is titania and 1-10 wt % Ag₃VO₄ QDs incorporated in the pores of titania) (Ag₃VO₄ prepared from silver nitrate and ammonium metavanadate) as thin film over 1 cm² area and integrated with 0.5θₚₜ@NiCu as a co-catalyst. This AL device was kept in 10 ml of deionized water at pH=7, wherein water acts as hydrogen source, in a quartz reactor and sealed using septum. The reaction mixture was thoroughly saturated with CO₂ using 99.9% CO₂ gas for about 40 min. To dissolve the maximum amount of CO₂ in water, the reaction flask was placed in ice bath (1-3° C.) at the time of saturation. The reaction flask was illuminated under one sun condition in static condition for at least 5 h. To analyze products in aqueous as well as gas phase, samples were withdrawn at steady interval of time using leak-tight syringe. Gas and liquid products are analyzed by GC and NMR methods.

With this AL device, CO, methane and methanol yield was observed in a range of 140-160, 5-10 and 90-100 μmol/mg·cm² (1 mg catalyst (Ag₃VO₄+TiO₂) coated over 1 cm² area), respectively, under one sun condition. The maximum conversion efficiency of carbon dioxide to all products was in the range of 40-50%. Selectivity of methanol was approximately 36% after 5 h of reaction. When the experiments were carried out in direct sunlight, higher range of product yield could be observed. CO, methane and methanol were observed in the range of 190-210, 10-15 and 140-160 μmol/mg·cm², respectively, under illumination of direct sunlight for 5 h of reaction time. The maximum conversion efficiency of carbon dioxide to C₁ products was found to increase further significantly by another 25-30% under direct sunlight, compared to one sun conditions. Further, direct sunlight exposure enhances the total CO₂ conversion to value added products. Generally, higher activity could be observed when direct sunlight is at its best with high solar flux. Here, the direct sunlight used herein contains 4-5% UV, ~45% Visible light, ~23% near IR light, and the remaining is IR light. Wavelength of the light and light power is important for reaction. Sunlight contains all these wavelengths and any of the light individually and with required power. FIG. 1B shows visible and UV absorption for AMVT and UV+Visible+near IR for AOVT. Light absorption is a testament for its activity, as it has been already demonstrated with sunlight, where the individual components % is lower, compared to artificially generated 100% UV or visible or near IR.

Product yields in μmol/mg·cm², as a function of irradiation time with 1 cm² area AMVT photoanode integrated with 0.5θₚₜ-NiCu alloy co-catalyst under one sun condition and direct sunlight are provided in Table 1 below:

TABLE 1
Product yields for AMVT photoanode integrated
with 0.5θ_{Pt}-NiCu alloy as co-catalyst

| | One Sun condition | | | Direct sunlight | | |
|---|---|---|---|---|---|---|
| Time | (100 mW/cm²) | | | (62-71 mW/cm²) | | |
| (in h.) | CO | CH₄ | CH₃OH | CO | CH₄ | CH₃OH |
| 1 | 62.3 | 0.8 | 23 | 41.5 | 1.3 | 33.5 |
| 3 | 104.6 | 2.7 | 62 | 104.9 | 4.8 | 97.2 |
| 5 | 156.9 | 5.8 | 91 | 207.4 | 9.2 | 157 |

### Example 9: Photocatalytic CO₂ Reduction with AOVT-Based AL Device (Batch Process)

1 cm² area AL device was prepared with 1 mg of Ag₃VO₄/TiO₂ (AOVT) (Ag₃VO₄ prepared from silver nitrate and sodium orthovanadate) and integrated with 0.5θₚₜ@NiCu as a co-catalyst. This AL device was kept in 10 ml of deionized water at pH=7, where water would act as in-situ hydrogen source in a quartz reactor and sealed using septum. The reaction mixture was thoroughly saturated with CO₂ using 99.9% CO₂ gas for about 40 min. To dissolve the maximum amount of CO₂ in water, the reaction flask was placed in ice bath at time of saturation. The reaction flask was illuminated under one sun condition in static condition for at least 5 h. To analyze products in aqueous as well as gas phases, sample were withdrawn at steady interval of time using leak-tight syringe. Gas and liquid products are analyzed by GC and NMR methods.

After 5 h of reaction time, 0.5θₚₜNiCu-AOVT AL device exhibited the formation of C₁ product in gas as well as in liquid phase along with C₂ product (mainly ethanol) as reduction products; O₂ was observed to be the oxidation product. With 0.5θₚₜNiCu-AOVT AL device, CO, methane, methanol and ethanol was observed in range of 90-100, 2-5, 90-100 and 12-17 μmol/mg·cm² (1 mg catalyst (Ag₃VO₄+TiO₂) coated over 1 cm² area), respectively, under one sun condition. The maximum conversion efficiency of carbon dioxide to C₁-C₂ products was in the range of 18-20%. Selectivity for methanol and ethanol was approximately 40-45% and 6-7%, respectively. When the experiments were carried out in direct sunlight, activity improved with significantly higher range of product yield observed in 5 h of reaction time. CO, methane, methanol and ethanol yield was observed in range of 130-150, 5-10, 80-110, 40-55 μmol/mg·cm², respectively, under illumination of direct sunlight. The maximum conversion efficiency of carbon dioxide to C₁-C₂ products increased to a higher range of 28-30% under solar light. Generally, higher activity could be observed experiments were carried out in direct sunlight. Product yields in μmol/mg·cm², as a function of irradiation time with 1 cm² area AOVT photoanode integrated with 0.5θₚₜ-NiCu alloy co-catalyst under one sun condition and direct sunlight are provided in Table 2 below:

TABLE 2
Product yields for AOVT photoanode integrated
with 0.5θ_{Pt}-NiCu alloy as co-catalyst

| Time | One Sun condition (100 mW/cm²) | | | | Direct sunlight | | | |
|---|---|---|---|---|---|---|---|---|
| (in h.) | CO | CH₄ | CH₃OH | C₂H₅OH | CO | CH₄ | CH₃OH | C₂H₅OH |
| 1 | 31.2 | 0.51 | 19.2 | 2.6 | 42.6 | 1.04 | 24.8 | 7.8 |
| 3 | 59.5 | 1.7 | 54.3 | 7.8 | 85.4 | 3.1 | 68.9 | 26.4 |
| 5 | 96.2 | 2.65 | 81.7 | 13 | 137.2 | 5.7 | 106 | 46 |

### Solar to Fuel Efficiency

Solar to fuel efficiency was calculated with the results obtained under direct sunlight for all fabricated devices. Equations employed for calculating STF is given below:

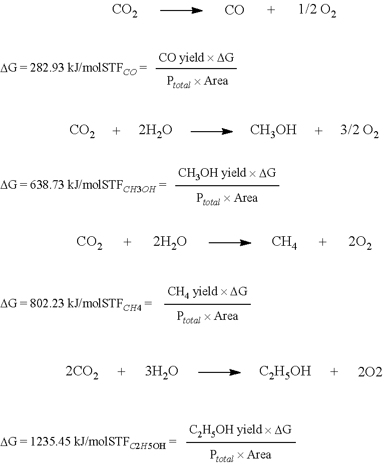

Power density (Pₜₒₜₐₗ) was assumed to be 63 mW/cm² for all calculations, and irradiation area was 1 cm². Respective products formation yield were taken in μmol/h. Table 3 below provides solar to fuel efficiency of fabricated devices in direct sunlight. Considering all product molecules are to be fuel, a combined STF of 14.7% is observed with both devices, which is higher than the reported values. Even if we assume a high solar power density of 70 mW/cm², the combined STF decreases to 13.2%, and still this value is higher than the reported value.

TABLE 3
Solar to fuel efficiency of fabricated devices in direct sunlight

| | Solar to Fuel Efficiency - STF (%) | | | | Combined |
|---|---|---|---|---|---|
| Device | CO | CH₄ | CH₃OH | C₂H₅OH | STF (%) |
| 0.5θPt@NiCu-AMVT | 5.17 | 0.65 | 8.84 | — | 14.66 |
| 0.5θPt@NiCu-AOVT | 3.4 | 0.4 | 5.9 | 5.01 | 14.71 |

### Example 10: Photocatalytic CO₂ Reduction (Batch Process) with NiCu—Ag₃VO₄/TiO₂ (AMVT) AL Device

As stated in example 2, Ag₃VO₄/TiO₂ (AMVT) photoanode was prepared by doctor blade followed by SILAR method and integrated with NiCu alloy co-catalyst. This device was subjected to the co-conversion of CO₂ with water, as stated in example 8. It is observed that this device is selective toward reduction of CO₂ and shows very low activity for methanol formation (0.23 μmol/h.mg) compared to its 0.5θₚₜ@NiCu-counterpart.

### Example 11: Photocatalytic CO₂ Reduction (Batch Process) with NiCu—Ag₃VO₄/TiO₂ (AOVT) AL Device

As stated in example 3, Ag₃VO₄/TiO₂ (AOVT) photoanode was prepared by doctor blade followed by SILAR method and integrated with NiCu alloy co-catalyst. This device was subjected to the co-conversion of CO₂ with water, as stated in example 9. It is observed that this device is selective toward reduction of CO₂ and shows very low activity for formation of C₂ product (0.22 μmol/h.mg to its 0.5θₚₜ@NiCu-counterpart).

### Example 12: Photocatalytic CO₂ Reduction (Batch Process)—Ni—Ag₃VO₄/TiO₂ (AMVT) AL Device

As stated in example 2, Ag₃VO₄/TiO₂ (AMVT) photoanode was prepared by doctor blade followed by SILAR method and integrated with Ni nanoparticles as co-catalyst. This device was subjected to the co-conversion of CO₂ with water, as stated in example 8. It is observed that this device is selective toward reduction of CO₂ and shows formation of C₁-gas products only.

### Example 13: Photocatalytic CO₂ Reduction (Batch Process)—Ni—Ag₃VO₄/TiO₂ (AOVT) AL Device

As stated in example 3, Ag₃VO₄/TiO₂ (AOVT) photoanode was prepared by doctor blade followed by SILAR method and integrated with Ni nanoparticles as co-catalyst. This device was subjected to the co-conversion of CO₂ with water, as stated in example 9. It is observed that this device is selective toward reduction of CO₂ and shows formation of C₁-gas products only.

### Example 14: Photocatalytic CO₂ Reduction (Batch Process)—Cu—Ag₃VO₄/TiO₂ (AMVT) AL Device

As stated in example 2, Ag₃VO₄/TiO₂ (AMVT) photoanode was prepared by doctor blade followed by SILAR method and integrated with Cu nanoparticles as co-catalyst. This device was subjected to the co-conversion of CO₂ with water, as stated in example 8. It is observed that this device is selective toward reduction of CO₂ and shows formation of C₁-gas products only.

### Example 15: Photocatalytic CO₂ Reduction (Batch Process)—Cu—Ag₃VO₄/TiO₂ (AOVT) AL Device

As stated in example 3, Ag₃VO₄/TiO₂ (AOVT) photoanode was prepared by doctor blade followed by SILAR method and integrated with Cu nanoparticles as co-catalyst. This device was subjected to the co-conversion of CO₂ with water, as stated in example 9. It is observed that this device is selective toward reduction of CO₂ and shows formation of C₁-gas products only.

### Example 16: Photocatalytic CO₂ Reduction with AMVT-Based Artificial Leaf (AL) Device (Batch Process)

As stated in example 2, larger size of AMVT AL devices of larger sizes (2.25 and 6.25 cm²) were prepared by application of SILAR method. The photoanode part of the artificial leaf device with Ag₃VO₄/TiO₂ is further integrated with 0.5θₚₜ-NiCu alloy as co-catalyst. The photocatalytic CO₂ reduction reaction of larger AMVT AL size devices has been explored in direct sunlight (as mentioned in example 8). 2.25 cm² AMVT AL device was kept in 25 ml and 6.25 cm² in 50 ml CO₂-saturated water. The product yields obtained from larger AL devices are provided in Table 4. A linear increase in the CO₂ conversion and products yield were observed when the reaction was evaluated for larger-size of device. 2.25 cm² device shows ~2 times larger product yield, while 6.25 cm² device shows ~4 times larger product yield, compared to 1 cm² device in direct sunlight.

TABLE 4
Product yields for 2.25 cm² & 6.25 cm² film of AMVT
photoanode integrated with 0.5θ_{Pt}-NiCu alloy as co-
catalyst in direct sunlight (62-71 mW/cm²)

| Time | 2.25 cm² device (μmol) | | | 6.25 cm² device (μmol) | | |
|---|---|---|---|---|---|---|
| (in h.) | CO | CH₄ | CH₃OH | CO | CH₄ | CH₃OH |
| 1 | 66.4 | 2.08 | 52.3 | 174.3 | 5.4 | 140.7 |
| 3 | 142 | 8.1 | 166.5 | 276.2 | 20.3 | 421.8 |
| 5 | 219.3 | 10.4 | 287.2 | 583.7 | 25.6 | 632.7 |

### Example 17: Photocatalytic CO₂ Reduction with AOVT-Based AL Device (Batch Process)

As stated in example 3, larger size of AOVT AL devices (2.25 and 6.25 cm²) sizes prepared by application of the SILAR method with uniform Ag₃VO₄ QDs in the pores of TiO₂. The photoanode part of the artificial leaf device with Ag₃VO₄/TiO₂ as photoanode material, is then integrated with 0.5θₚₜ-NiCu alloy as co-catalyst. The photocatalytic CO₂ reduction reaction of larger AOVT AL size device has been further explored in direct sunlight as mentioned in example 9 where AL device was kept in 25 ml CO₂-saturated water for 2.25 cm² device and 50 ml of CO₂-saturated water for 6.25 cm² size device. The product yield obtained from larger AOVT AL devices is provided in Table 5. A linear increase in product yield and CO₂ conversion was observed when the reaction was tested for larger-size of device. 2.25 cm² device shows ~2 times product yield while 6.25 cm² device shows ~4 times product yield compared to 1 cm² device in direct sunlight.

TABLE 5
Product yields for 2.25 cm² & 6.25 cm² film AOVT photoanode integrated
with 0.5θ_{Pt}-NiCu alloy as co- catalyst in direct sunlight (62-71 mW/cm²)

| Time | 2.25 cm² device (μmol) | | | | 6.25 cm² device (μmol) | | | |
|---|---|---|---|---|---|---|---|---|
| (h) | CO | CH₄ | CH₃OH | C₂H₅OH | CO | CH₄ | CH₃OH | C₂H₅OH |
| 1 | 57.5 | 1.6 | 34.7 | 11.4 | 166.1 | 4.4 | 94.3 | 31.9 |
| 3 | 128.1 | 4.5 | 128.2 | 40.9 | 315.9 | 12.6 | 266.6 | 103.7 |
| 5 | 209.1 | 8.7 | 174.9 | 73.6 | 480.2 | 22.2 | 436.7 | 184 |

### Example 18: a Comparison of Photocatalytic CO₂ Reduction with AMVT and AOVT-Based AL Devices (Batch Process)

Results obtained in examples 16 and 17 are compared in the Table 6 and 7 for 2.25 and 6.25 cm² devices respectively. About 35% decrease in solar to fuel efficiency is observed with both larger size (2.25 and 6.25 cm²) devices compared to 1 cm² device. Nonetheless product ratio remains the same within the experimental accuracy of 10%, hinting a possibly decreased utilization of charge carriers for CO₂ reduction reaction.

TABLE 6
Solar to fuel efficiency of 2.25
cm² fabricated devices in direct sunlight

| | Solar to Fuel Efficiency - STF (%) | | | | Combined |
|---|---|---|---|---|---|
| Device | CO | CH₄ | CH₃OH | C₂H₅OH | STF (%) |
| 0.5θPt@NiCu- | 3.54 | 0.32 | 7.19 | — | 11.05 |
| AMVT | | | | | |
| 0.5θPt@NiCu- | 2.54 | 0.28 | 4.38 | 3.56 | 10.76 |
| AOVT | | | | | |

TABLE 7
Solar to fuel efficiency of 6.25
cm² fabricated devices in direct sunlight

| | Solar to Fuel Efficiency - STF (%) | | | | Combined |
|---|---|---|---|---|---|
| Device | CO | CH₄ | CH₃OH | C₂H₅OH | STF (%) |
| 0.5θPt@NiCu-AMVT | 3.32 | 0.29 | 5.7 | — | 9.31 |
| 0.5θPt@NiCu-AOVT | 1.91 | 0.25 | 3.93 | 3.2 | 9.29 |

### Advantages of the Invention

Simple & efficient method for conversion of mixture of CO₂ and water to value added liquid & gaseous fuels in direct sunlight with artificial leaf device with a 14.7% efficiency.
Multi-functional photoanode was prepared by assembling ionic-precursors and converting them to light-absorbing photocatalyst quantum dots & concurrent electronic and structural integration in the micro and mesopores of wide band gap semiconductor is provided.
Concurrent activation of carbon dioxide and water to value added chemicals in direct sunlight is demonstrated by batch and semi-continuous processes. Methanol and ethanol are major liquid products, and there are handles to fine tune selectivity of them.
Significant increase in process and catalyst temperature due to solar irradiation enhances the rate of reaction at no cost.
Entire reaction aspect can be carried out with different light sources, such as direct sunlight, standard laboratory light sources, UV, UV+Visible light sources.
Product selectivity & conversion efficiency is tuned by employing different co-catalyst.
Building C—C bond towards making ethanol under present experimental conditions is unique, and not reported by prior art. This is further supported by 711 trillion heterojunctions per mg of photoanode material, which is also not reported in prior art. Calculation of number of heterojunctions itself has not been reported in any prior art.
The unique combination of Ag₃VO₄ QDs in the pores of titania leading to effective light absorption and highest sustainable activity, as well as scalability.
With no pH adjustment, sustainable CO₂ conversion activity to value-added products has been demonstrated in direct sunlight.
By using earth-abundant and economically viable NiCu-Half monolayer Pt as a co-catalyst and Ag₃VO₄/TiO₂ as photoanode, the developed artificial leaf reduces CO₂ to C₁/C₂ compounds in presence of direct sunlight i.e., methanol and ethanol which is highly distinctive.
Ag₃VO₄ Quantum dots play a vital role in enhancing CO₂ reduction activity by creating trillions of heterojunction in a pore of TiO₂ throughout the film leading to effective separation of electron-hole pair and well dispersion of electron towards the cathode, thus making possible multi-electron CO₂ reduction reaction ultimately lead to greater yield and a higher rate of formation.
The formation rate for methanol and ethanol in saturated CO₂ conditions in pure water without using any sacrificial agent is better or effective, with a combined solar-to-fuel efficiency of 14.7%.

1. A photocatalytic material, comprising:
a semiconductor quantum dots, a porous semiconductor, and a support; wherein the semiconductor quantum dots comprise a 3d transition metal oxide, a 4d transition metal oxide, and/or mixtures thereof,
wherein the porous semiconductor is supported onto said support in the form of a thin film; and
wherein the semiconductor quantum dots are integrated, structurally and electronically, into pores of the porous semiconductor and on exterior surface of the semiconductor.

2. The photocatalytic material as claimed in claim 1, wherein the 3d transition metal oxide is oxide of metal selected from titanium (Ti), vanadium (V), chromium (Cr), manganese (Mn), iron (Fe), cobalt (Co), nickel (Ni), copper (Cu) and zinc (Zn); and wherein the 4d transition metal oxide is oxide of metal selected from zirconium (Zr), niobium (Nb), molybdenum (Mo), ruthenium (Ru), rhodium (Rh), palladium (Pd), and silver (Ag).

3. The photocatalytic material as claimed in claim 1, wherein the semiconductor quantum dots are selected from Ag₃VO₄ nanoparticles; wherein the semiconductor quantum dots are in orthorhombic crystal structure and monoclinic crystal structure or mixture thereof.

4. The photocatalytic material as claimed in claim 1, wherein the porous semiconductor is selected from TiO₂, ZnO and polymorphs thereof.

5. The photocatalytic material as claimed in claim 1, wherein the support is selected from glass plate, FTO plate, indium tin oxide (ITO) glass plate, a fluorine-doped tin oxide (FTO) glass plate, silicon wafer and steel plate.

6. The photocatalytic material as claimed in claim 1, wherein the semiconductor quantum dots have a particle size ranging from 1 nm to 10 nm.

7. The photocatalytic material as claimed in claim 1, wherein the porous semiconductor is supported onto said support in the form of a thin film has a thickness in the range of 5-20 μm or 8 to 14 μm.

8. The photocatalytic material as claimed in claim 1, wherein the material comprises heterojunctions between said semiconductor quantum dots and porous semiconductor, wherein the number of heterojunctions is in range of 276 to 711 trillions/cm².mg.

9. A process of preparation of photocatalytic material as claimed in claim 1, wherein the process comprises steps:
i) preparing a porous semiconductor supported onto a support by coating porous semiconductor paste onto the support to obtain a thin film;
ii) drying the film of step (i) at a temperature in the range of 50 to 70° C. for a time period in the range of 1.5 to 3 hours;
iii) calcining the dried film of step (ii) at a temperature in the range of 400 to 500° C. for a time period in the range of 20 to 45 minutes to obtain the porous semiconductor supported onto a support as thin film; and
iv) adding a 1^{st} and/or 2^{nd} ionic precursor corresponding to a semiconductor quantum dots with said porous semiconductor supported onto the support of step (iii) via a successive ionic layer adsorption and reaction (SILAR) method to obtain the photocatalytic material.

10. The process as claimed in claim 9, wherein the porous semiconductor paste is prepared by process steps of:
i) stirring and sonicating porous semiconductor powder in a solvent or mixture of solvents selected from ethanol and glacial acetic acid for a time period in the range of 5 to 25 minutes to obtain a mixture;
ii) mixing, stirring and sonicating an ethyl cellulose with said mixture of step i) for a time period in the range of 5 to 25 minutes; and
iii) mixing, stirring and sonicating terpeniol with the mixture of step ii) for a time period in the range of 20 to 45 minutes to obtain the porous semiconductor paste.

11. The process as claimed in claim 9, wherein the SILAR method of step (iv) comprises the steps of:
a) immersing the porous semiconductor supported onto a support thin film in an aqueous solution of 1^{st} ionic precursor at a temperature in the range of 25 to 35° C. for a time period in the range of 5 to 60 seconds;
b) immersing the film of step a) in 2^{nd} ionic precursor at a temperature in the range of 70-75° C. for a time period in the range of 5 to 60 seconds;
c) repeating the process of step a) and b) for at least two times to obtain a crude photocatalytic material;
d) rinsing the crude material of step c) with water;
e) drying the rinsed material of step d) at a temperature in the range of 60-70° C. for a time period in the range of 1-2 hours;
f) annealing the dried material of step e) at a temperature in the range of 400 to 500° C. for a time period in the range of 1.5 to 3 hours to obtain the photocatalytic material.

12. The process as claimed in claim 9, wherein the 1st ionic precursor is silver nitrate having the concentration in range of 10-300 mmol.

13. The process as claimed in claim 9, wherein the 2^{nd} ionic precursor is selected from ammonium metavanadate and sodium orthovanadate and wherein the concentration of 2^{nd} ionic precursor is in range of 10-300 mmol.

14. A process of preparation of C₁/C₂ compounds with the photocatalytic material as claimed in claim 1, wherein said process comprises steps of:
a) placing the photocatalytic material with a co-catalyst in a reactor and adding water as a hydrogen source to the reactor;
b) saturating the reactor of step a) with CO₂ gas at a temperature in the range of 1 to 5° C. for a time period in the range of 30 to 60 minutes to obtain a CO₂ saturated mixture;
c) exposing the mixture of step b) with a light at a pH in the range of 6.8-7.2 for a time period in the range of 4 to 10 hours to obtain the C₁/C₂ compounds;
wherein the C₁/C₂ compounds are selected from CO, CH₄, methanol, ethanol and mixtures thereof.

15. The process as claimed in claim 14, wherein the co-catalyst is a metal selected from platinum (Pt), nickel (Ni), copper (Cu), nickel-copper (NiCu) alloy, nickel iron (NiFe) alloy, platinum coated NiCu alloy, and mixture thereof.

16. The process as claimed in claim 14, wherein the light is selected from a UV-visible-near IR light, a visible light, a visible-near IR light and direct sunlight or combinations thereof.

17. The process as claimed in claim 11, wherein the 1st ionic precursor is silver nitrate having the concentration in range of 10-300 mmol.

18. The process as claimed in claim 11, wherein the 2^{nd} ionic precursor is selected from ammonium metavanadate and sodium orthovanadate and wherein the concentration of 2^{nd} ionic precursor is in range of 10-300 mmol.
